(19) United States
(12) Patent Application Publication
(10) Pub. No.: US 2013/0242578 A1
(43) Pub. Date: Sep. 19, 2013

(54) HIGH THERMALLY CONDUCTIVE COMPOSITES AND ILLUMINATION DEVICE

(71) Applicant: INDUSTRIAL TECHNOLOGY RESEARCH INSTITUTE, (US)

(72) Inventors: Chien-Ming CHEN, Yangmei Township (TW); Yao-Chu CHUNG, Kaohsiung City (TW); Fu-Ming CHIEN, Hsinchu City (TW); Chun-Hsiung LIAO, New Taipei City (TW); Chih-Jen CHANG, Toufen Township (TW); Chin-Lang WU, Tongsiao Township (TW); Tien-Jung HUANG, Zhudong Township (TW); Cheng-Chou WONG, Jhudong Township (TW); Chih-Chung CHANG, Sioushuei Township (TW)

(73) Assignee: INDUSTRIAL TECHNOLOGY RESEARCH INSTITUTE, Hsinchu (TW)

(21) Appl. No.: 13/889,142

(22) Filed: May 7, 2013

Related U.S. Application Data
(63) Continuation-in-part of application No. 13/467,976, filed on May 9, 2012.

(30) Foreign Application Priority Data
Dec. 21, 2011 (TW) 100147696
Dec. 14, 2012 (TW) 101147362

(51) Int. Cl. C09K 5/14; F21V 29/00

(52) U.S. Cl. CPC C09K 5/14; F21V 29/242
USPC 362/382; 252/75; 252/76

(57) ABSTRACT

Disclosed is a high thermally conductive composite, including a first composite and a second composite having a co-continuous and incompatible dual-phase manner. The first composite consists of glass fiber distributed in polyphenylene sulfide (PPS), acrylonitrile-butadiene-styrene copolymer (ABS), polybutylene terephthalate (PBT), poly(ε-caprolactam) (Nylon 6), polyhexamethylene adipamide (nylon 66), or polypropylene (PP). The second composite consists of carbon material distributed in polyethylene terephthalate.

### CROSS REFERENCE TO RELATED APPLICATIONS

This application is a Continuation-In-Part of pending U.S. patent application Ser. No. 13/467,976, filed on May 9, 2012 entitled “High thermally conductive composites”, which claims priority of Taiwan Patent Application No. 100147696, filed on Dec. 21, 2011, the disclosure of which is hereby incorporated by reference herein in its entirety. The application is based on, and claims priority from, Taiwan Application Serial Number 101147362, filed on Dec. 14, 2012, which claims priority from earlier Taiwan Patent Application No. 100147696, filed on Dec. 21, 2011, the disclosure of which is hereby incorporated by reference herein in its entirety.

### TECHNICAL FIELD

The technical field relates to high thermally conductive composites and illumination device.

### BACKGROUND

In recent years, electronic devices have tended to be thinner, lighter, smaller, and shorter, but the capability and processing speed has increased. This means that electronic devices need better thermal dissipation, and the demand for thermal dissipation materials has grown. For example, thermal management industry sales reached 18 trillion New Taiwan Dollars in 2008. Most conventional thermal dissipation products have casting aluminum or filled thermoset epoxy resin which is difficult to process, high in cost, and narrow in application. Thermally conductive plastics not only have a thermal conductivity similar to that of metal and ceramics, but also have other advantages, which are unique to plastic, such as designability, performance, and cost. For example, thermally conductive plastics have an average thermal dissipation, are light-weight (40% to 50% lighter than aluminum), have multiple selections of basis resin, non-expensive and convenient to mold and processes thus enabling a high range of design freedom.

Most conventional thermally conductive products introduce a large amount of thermally conductive powder such as ceramic powder (BN, SiC, or MN) and electrically conductive fiber such as carbon fiber and carbon nanotube into the thermoplastic polymer. The large amount of the thermally conductive powder is necessary to produce an excellent thermally conductive effect; however, it may dramatically reduce the end-point processibility and the physical properties of the composite. In addition, thermally conductive powder is a major part of the cost of thermally conductive composites. The large amount of thermally conductive powder will make the composite lose its competitiveness.

Accordingly, a novel thermally conductive composite having a lower amount of conductive powder without sacrificing the conductivity thereof is called for.

### SUMMARY

One embodiment of the disclosure provides a high thermally conductive composite, comprising: a first composite consisting of glass fiber distributed into polyphenylene sulfide, acrylonitrile-butadiene-styrene copolymer, polybutylene terephthalate, poly(ε-caprolactam), polyhexamethylene adipamide, or polypropylene; and a second composite consisting of carbon material distributed into polyethylene terephthalate, wherein the first composite and the second composite have a co-continuous and incompatible dual-phase manner.

One embodiment of the disclosure provides an illumination device, comprising: a lamp base; and a heat dissipation module disposed on the lamp base, wherein the heat dissipation module is formed based on the described high thermally conductive composite.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a manner of a high thermally conductive composite in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

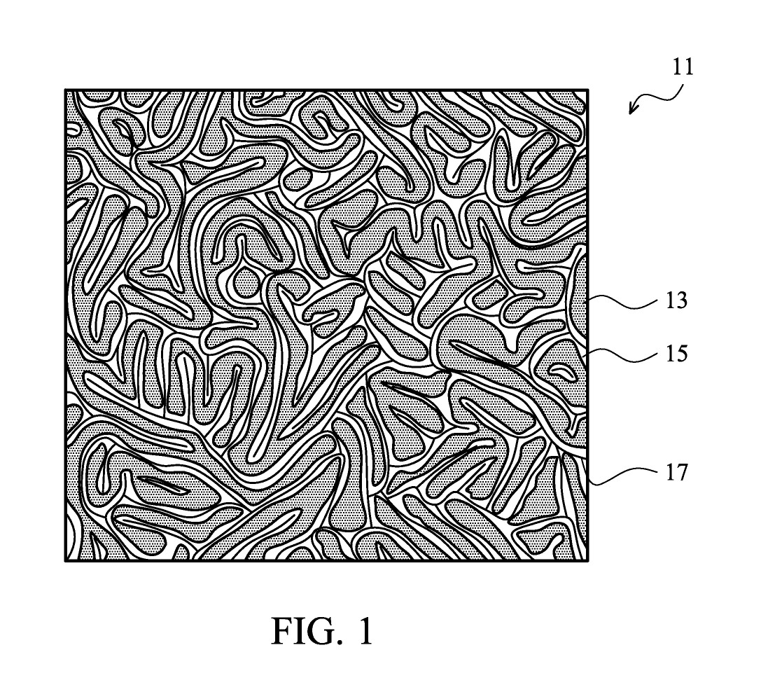

As shown in FIG. 1, a high thermally conductive composite 11 in one embodiment of the disclosure is composed of a first composite 13 and a second composite 15. The first composite 13 and the second composite 15 have a co-continuous and incompatible dual-phase manner. The first composite 13 consists of a glass fiber distributed into a polyphenylene sulfide (PPS), an acrylonitrile butadiene styrene copolymer (ABS), a polybutylene terephthalate (PBT), a poly(ε-caprolactam) (Nylon 6), a polyhexamethylene adipamide (Nylon 66), or polypropylene (PP). The glass fiber may enhance the mechanical strength of the high thermally conductive composite 11, and the PPS, ABS, PBT, Nylon 6, Nylon 66, and PP are thermal resistant polymers. In one embodiment, the glass fiber and the PPS, ABS, PBT, Nylon 6, Nylon 66, or PP have a weight ratio of 10:90 to 40:60. An overly high amount of the glass fiber will make the first composite 13 lose its fluidity or even lose its processibility. An overly low amount of the glass fiber will not efficiently enhance the mechanical strength of the high thermally conductive composite 11. In one embodiment, the PPS, ABS, PBT, Nylon 6, Nylon 66, or PP has a melt flow index of 70 g/min to 5000 g/min. A PPS, ABS, PBT, Nylon 6, Nylon 66, or PP having an overly high melt flow index will make the first composite 13 lose its fluidity or even lose its processibility.

The second composite 15 consists of a carbon material 17 distributed into a polyethylene terephthalate (PET). As shown in FIG. 1, the carbon material 17 is only distributed into the PET of the second composite 15, and connects to each other to provide thermally conductive paths. Because the carbon material 17 is not distributed into the first composite 13, the amount of the carbon material 17 can be reduced. The PET is a thermoplastic polymer, which benefits the compounding and molding processes. In one embodiment, the PET and the carbon material 17 have a weight ratio of 10:90 to 70:30. An overly high amount of the carbon material 17 will make the second composite 15 lose its fluidity or even lose its processibility, and make the high thermally conductive composite 11 lose its mechanical strength. An overly low amount of the carbon material 17 cannot make the high thermally conductive composite 11 have sufficient thermal conductivity. In one embodiment, the carbon material 17 can be graphite, graphene, carbon fiber, carbon nanotube, or combinations thereof. The carbon material 17 has a size of 150 μm to 600 μm. In one embodiment, the PET has an intrinsic viscosity of 0.4 dL/g to 2 dL/g.

In one embodiment, the first composite 13 and the second composite 15 have a weight ratio of 1:9 to 3:7. An overly low amount of the first composite 13 will cause the high thermally conductive material 11 to have an insufficient mechanical strength. An overly high amount of the first composite 13 will cause the high thermally conductive material 11 to have an insufficient thermal conductivity. An appropriate ratio of the glass fiber and the PPS, ABS, PBT, Nylon 6, Nylon 66, or PP are compounded to form the first composite 13. An appropriate ratio of the first composite 13, the carbon material 17, and the PET are compounded to form the product, wherein the carbon material 17 and the PET are compounded to form the second composite 15. The product is sliced, and the sliced face is then analyzed by a microscopy to show that the first composite 13 and the second composite 15 are a co-continuous phase. The glass fiber is only distributed into the first composite 13 and not distributed into the second composite 15, and the carbon material 17 is only distributed into the second composite 15 and not distributed into the first composite 13. Generally, the high thermally conductive composite should have a thermal conductivity greater than 1.0 W/m·K and a heat deformation temperature (thermal resistance) greater than 100° C. The high thermally conductive composite can be applied as a heat dissipation device, such as a heat dissipation module for an LED. See U.S. application Ser. Nos. 29/431,081 and 13/410,307. For example, an illumination device may include a lamp base and a heat dissipation module disposed thereon, and the heat dissipation module is formed of the high thermally conductive composite.

It will be apparent to those skilled in the art that various modifications and variations can be made to the disclosed embodiments. It is intended that the specification and examples be considered as exemplary only, with a true scope of the disclosure being indicated by the following claims and their equivalents.

### EXAMPLES

The raw material sources, equipments, and analysis instruments are described as below:

PPS was P-4 commercially available from Chevron Phillips Chemical Company.

Glass fiber was R-4 commercially available from Chevron Phillips Chemical Company.

PET was 5015W commercially available from Shinkong Synthetic Fibers Corporation, Taiwan.

ABS was D670 commercially available from Grand pacific petrochemical corporation.

PC (polycarbonate) was 399×95997 B commercially available from RTP Company.

PBT was DE3011 commercially available from Shinkong.

Nylon 6 was PTF-212-11 commercially available from Sabic Konduit.

Nylon 66 was CM3004G30 commercially available from Toray.

PP was 6733 commercially available from LCY CHEMICAL Corporation.

Graphite powder was natural graphite commercially available from Taiwan Maxwave Co., Ltd.

Carbon fiber was DKD commercially available from Cytec. Industrial.

Compounding equipment was a twin screw extruder commercially available from Coperion Werner & Pfleiderer.

The thermal conductivity of the products was measured according to the ISO/DIS 22007-2 standard by the Transient Plane Source commercially available from Hot Disk AB.

### Comparative Example 1

80 parts by weight of the PPS and 20 parts by weight of the glass fiber were put in the compounding equipment to form a composite of a single polymer. The composite had a heat deformation temperature (HDT) of 220.1° C. and a thermal conductivity of 0.29 W/m·K.

### Comparative Example 2

60 parts by weight of the PPS and 40 parts by weight of the graphite powder were charged in the compounding equipment to form a composite of a single polymer. The composite had a heat deformation temperature (HDT) of 195.5° C. and a thermal conductivity of 0.90 W/m·K.

### Comparative Example 3

70 parts by weight of the composite in Comparative example 1 (PPS/glass fiber=80/20) and 30 parts by weight of the graphite powder were charged in the compounding equipment for mixing. The mixture could not form a composite to be stretched, and the properties of the mixture were too poor for processing.

### Comparative Example 4

65 parts by weight of the PET and 35 parts by weight of the graphite powder were charged in the compounding equipment to form a composite of a single polymer. The composite had a heat deformation temperature (HDT) of 113.9° C. and a thermal conductivity of 2.33 W/m·K.

### Comparative Example 5

60 parts by weight of the PET and 40 parts by weight of the graphite powder were charged in the compounding equipment to form a composite of a single polymer. The composite had a heat deformation temperature (HDT) of 105.0° C. and a thermal conductivity of 0.80 W/m·K.

### Comparative Example 6

Less than 60 parts by weight of the PC and greater than 40 parts by weight of the carbon fiber were charged in the compounding equipment to form a composite of a single polymer. The composite had a heat deformation temperature (HDT) of 143° C. and a thermal conductivity of 2.20 W/m·K.

### Comparative Example 7

Less than 60 parts by weight of the Nylon 6 and greater than 40 parts by weight of the graphite powder were charged in the compounding equipment to form a composite of a single polymer. The composite had a heat deformation temperature (HDT) of 180° C. and a thermal conductivity of 0.9 W/m·K.

### Comparative Example 8

70 parts by weight of the PET and 30 parts by weight of the graphite powder were charged in the compounding equipment to form a composite of a single polymer. The composite had a heat deformation temperature (HDT) of 95.4° C. and a thermal conductivity of 1.7 W/m·K.

### Example 1

10 parts by weight of the composite (PPS/glass fiber=80/20 in weight), 45 parts by weight of the PET, and 45 parts by weight of the graphite powder were charged in the compounding equipment to form a composite of a dual-phase polymer. The composite had a heat deformation temperature (HDT) of 191.6° C. and a thermal conductivity of 2.56 W/m·K.

### Example 2

20 parts by weight of the composite (PPS/glass fiber=80/20 in weight), 40 parts by weight of the PET, and 40 parts by weight of the graphite powder were charged in the compounding equipment to form a composite of a dual-phase polymer. The composite had a heat deformation temperature (HDT) of 196.8° C. and a thermal conductivity of 2.43 W/m·K.

### Example 3

30 parts by weight of the composite (PPS/glass fiber=80/20 in weight), 35 parts by weight of the PET, and 35 parts by weight of the graphite powder were charged in the compounding equipment to form a composite of a dual-phase polymer. The composite had a heat deformation temperature (HDT) of 206.6° C. and a thermal conductivity of 2.47 W/m·K.

The raw material ratios and properties of the products in Comparative Examples 1 to 4 and Examples 1 to 3 were tabulated and are shown in Table 1.

TABLE 1

| | Comparative | Comparative | Comparative | Comparative | | | |
|---|---|---|---|---|---|---|---|
| | example 1 | example 2 | example 3 | example 4 | Example 1 | Example 2 | Example 3 |
| PPS/glass | 100 | 0 | 70 | 0 | 10 | 20 | 30 |
| fiber = 80/20 | | | | | | | |
| PPS | 0 | 60 | 0 | 0 | 0 | 0 | 0 |
| PET | 0 | 0 | 0 | 65 | 45 | 40 | 35 |
| Graphite | 0 | 40 | 30 | 35 | 45 | 40 | 35 |
| Graphite | 0 | 40 | 30 | 35 | 45 | 40 | 35 |
| content (wt %) | | | | | | | |
| Manner | Single polymer | Single polymer | Single polymer | Single polymer | Dual-phase | Dual-phase | Dual-phase |
| | | | | | polymer | polymer | polymer |
| HDT (° C.) | 220.1 | 195.5 | — | 113.9 | 191.6 | 196.8 | 206.6 |
| Thermal | 0.29 | 0.90 | — | 2.33 | 2.56 | 2.43 | 2.47 |
| conductivity | | | | | | | |
| (W/m · K) | | | | | | | |
| Note | | | Could not be | | | | |
| | | | processed | | | | |

### Example 4

30 parts by weight of the composite (PPS/glass fiber=80/20 in weight), 35 parts by weight of the PET, and 35 parts by weight of the carbon fiber were charged in the compounding equipment to form a composite of a dual-phase polymer. The composite had a heat deformation temperature (HDT) of 161.4° C. and a thermal conductivity of 1.34 W/m·K.

The raw material ratios and properties of the products in Comparative Examples 4 to 7 and Examples 3 to 4 were tabulated and are shown in Table 2.

TABLE 2

| | Comparative | Comparative | Comparative | Comparative | | |
|---|---|---|---|---|---|---|
| | example 4 | example 5 | example 6 | example 7 | Example 3 | Example 4 |
| PPS/glass fiber = | 0 | 0 | 0 | 0 | 30 | 30 |
| 80/20 | | | | | | |
| PET | 65 | 60 | 0 | 0 | 35 | 35 |
| Graphite | 35 | 0 | >40% | >40% | 35 | 0 |
| Carbon fiber | 0 | 40 | 0 | 0 | 0 | 35 |
| Carbon material | 35 | 40 | >40% | >40% | 35 | 35 |
| content (wt %) | | | | | | |
| Manner | Single | Single | Single | Single | Dual- | Dual- |
| | polymer | polymer | polymer | polymer | phase | phase |
| | | | | | polymer | polymer |
| HDT (° C.) | 113.9 | 105.0 | 143 | 180 | 206.6 | 161.4 |
| Thermal | 2.33 | 0.80 | 2.20 | 0.9 | 2.47 | 1.34 |
| conductivity | | | | | | |
| (W/m · K) | | | | | | |

### Example 5

The PPS, the glass fiber, the PET, and the graphite powder were weighted according to ratios of 10 parts by weight of a first composite (PPS/glass fiber=90/10 in weight) and 90 parts by weight of a second composite (PET/graphite powder=70/30 in weight), and then charged in the compounding equipment to form a composite of a dual-phase polymer. The composite had a heat deformation temperature (HDT) of 164.6° C. and a thermal conductivity of 1.93 W/m·K.

### Example 6

The PPS, the glass fiber, the PET, and the graphite powder were weighted according to ratios of 30 parts by weight of a first composite (PPS/glass fiber=90/10 in weight) and 70 parts by weight of a second composite (PET/graphite powder=70/30 in weight), and then charged in the compounding equipment to form a composite of a dual-phase polymer. The composite had a heat deformation temperature (HDT) of 166.3° C. and a thermal conductivity of 1.11 W/m·K.

### Example 7

The PPS, the glass fiber, the PET, and the graphite powder were weighted according to ratios of 50 parts by weight of a first composite (PPS/glass fiber=90/10 in weight) and 50 parts by weight of a second composite (PET/graphite powder=70/30 in weight), and then charged in the compounding equipment to form a composite of a dual-phase polymer. The composite had a heat deformation temperature (HDT) of 166.9° C. and a thermal conductivity of 0.81 W/m·K.

### Example 8

The PPS, the glass fiber, the PET, and the graphite powder were weighted according to ratios of 10 parts by weight of a first composite (PPS/glass fiber=90/10 in weight) and 90 parts by weight of a second composite (PET/graphite powder=50/50 in weight), and then charged in the compounding equipment to form a composite of a dual-phase polymer. The composite had a heat deformation temperature (HDT) of 192.9° C. and a thermal conductivity of 2.52 W/m·K.

### Example 9

The PPS, the glass fiber, the PET, and the graphite powder were weighted according to ratios of 30 parts by weight of a first composite (PPS/glass fiber=90/10 in weight) and 70 parts by weight of a second composite (PET/graphite powder=50/50 in weight), and then charged in the compounding equipment to form a composite of a dual-phase polymer. The composite had a heat deformation temperature (HDT) of 193.7° C. and a thermal conductivity of 2.47 W/m·K.

### Example 10

The PPS, the glass fiber, the PET, and the graphite powder were weighted according to ratios of 50 parts by weight of a first composite (PPS/glass fiber=90/10 in weight) and 50 parts by weight of a second composite (PET/graphite powder=50/50 in weight), and then charged in the compounding equipment to form a composite of a dual-phase polymer. The composite had a heat deformation temperature (HDT) of 207.4° C. and a thermal conductivity of 1.28 W/m·K.

The raw material ratios and properties of the products in Comparative Example 8 and Examples 5 to 10 were tabulated and are shown in Table 3.

TABLE 3

| | Comparative | | | | | | Example |
|---|---|---|---|---|---|---|---|
| | example 8 | Example 5 | Example 6 | Example 7 | Example 8 | Example 9 | 10 |
| PPS/glass fiber = 90/10 | 0 | 10 | 30 | 50 | 10 | 30 | 50 |
| PET/graphite = 70/30 | 100 | 90 | 70 | 50 | 0 | 0 | 0 |
| PET/graphite = 50/50 | 0 | 0 | 0 | 0 | 90 | 70 | 50 |
| Graphite content (wt %) | 30 | 27 | 21 | 15 | 45 | 35 | 25 |
| Manner | Single | Dual- | Dual- | Dual- | Dual- | Dual- | Dual- |
| | polymer | phase | phase | phase | phase | phase | phase |
| | | polymer | polymer | polymer | polymer | polymer | polymer |
| HDT (° C.) | 95.4 | 164.6 | 166.3 | 166.9 | 192.9 | 193.7 | 207.4 |
| Thermal | 1.7 | 1.93 | 1.11 | 0.81 | 2.52 | 2.47 | 1.28 |
| conductivity(W/m · K) | | | | | | | |

### Example 11

The PPS, the glass fiber, the PET, and the graphite powder were weighted according to ratios of 10 parts by weight of a first composite (PPS/glass fiber=80/20 in weight) and 90 parts by weight of a second composite (PET/graphite powder=70/30 in weight), and then charged in the compounding equipment to form a composite of a dual-phase polymer. The composite had a heat deformation temperature (HDT) of 174.2° C. and a thermal conductivity of 1.98 W/m·K.

### Example 12

The PPS, the glass fiber, the PET, and the graphite powder were weighted according to ratios of 30 parts by weight of a first composite (PPS/glass fiber=80/20 in weight) and 70 parts by weight of a second composite (PET/graphite powder=70/30 in weight), and then charged in the compounding equipment to form a composite of a dual-phase polymer. The composite had a heat deformation temperature (HDT) of 190.7° C. and a thermal conductivity of 1.09 W/m·K.

### Example 13

The PPS, the glass fiber, the PET, and the graphite powder were weighted according to ratios of 50 parts by weight of a first composite (PPS/glass fiber=80/20 in weight) and 50 parts by weight of a second composite (PET/graphite powder=70/30 in weight), and then charged in the compounding equipment to form a composite of a dual-phase polymer. The composite had a heat deformation temperature (HDT) of 191° C. and a thermal conductivity of 0.98 W/m·K.

### Example 14

The PPS, the glass fiber, the PET, and the graphite powder were weighted according to ratios of 10 parts by weight of a first composite (PPS/glass fiber=80/20 in weight) and 90 parts by weight of a second composite (PET/graphite powder=50/50 in weight), and then charged in the compounding equipment to form a composite of a dual-phase polymer. The composite had a heat deformation temperature (HDT) of 191.6° C. and a thermal conductivity of 2.56 W/m·K.

### Example 15

The PPS, the glass fiber, the PET, and the graphite powder were weighted according to ratios of 30 parts by weight of a first composite (PPS/glass fiber=80/20 in weight) and 70 parts by weight of a second composite (PET/graphite powder=50/50 in weight), and then charged in the compounding equipment to form a composite of a dual-phase polymer. The composite had a heat deformation temperature (HDT) of 206.6° C. and a thermal conductivity of 2.43 W/m·K.

### Example 16

The PPS, the glass fiber, the PET, and the graphite powder were weighted according to ratios of 50 parts by weight of a first composite (PPS/glass fiber=80/20 in weight) and 50 parts by weight of a second composite (PET/graphite powder=50/50 in weight), and then charged in the compounding equipment to form a composite of a dual-phase polymer. The composite had a heat deformation temperature (HDT) of 215.7° C. and a thermal conductivity of 1.38 W/m·K.

The raw material ratios and properties of the products in Comparative Example 8 and Examples 11 to 16 were tabulated and are shown in Table 4.

TABLE 4

| | Comparative | Example | Example | Example | Example | Example | Example |
|---|---|---|---|---|---|---|---|
| | example 8 | 11 | 12 | 13 | 14 | 15 | 16 |
| PPS/glass fiber = 80/20 | 0 | 10 | 30 | 50 | 10 | 30 | 50 |
| PET/graphite = 70/30 | 100 | 90 | 70 | 50 | 0 | 0 | 0 |
| PET/graphite = 50/50 | 0 | 0 | 0 | 0 | 90 | 70 | 50 |
| Graphite content (wt %) | 30 | 27 | 21 | 15 | 45 | 35 | 25 |
| Manner | Single | Dual- | Dual- | Dual- | Dual- | Dual- | Dual- |
| | polymer | phase | phase | phase | phase | phase | phase |
| | | polymer | polymer | polymer | polymer | polymer | polymer |
| HDT | 95.4 | 174.2 | 190.7 | 191 | 191.6 | 206.6 | 215.7 |
| Thermal conductivity | 1.7 | 1.98 | 1.09 | 0.98 | 2.56 | 2.43 | 1.38 |
| (W/m · K) | | | | | | | |

As shown in Examples and Comparative examples, although the composites of the dual-phase polymer and the composites of the single polymer had same carbon material content, the composites of the dual-phase polymer had higher thermal conductivity or higher thermal resistance than that of the composites of the single polymer.

### Example 17

The ABS, the glass fiber, the PET, and the graphite powder were weighted according to ratios of 30 parts by weight of a first composite (ABS/glass fiber=21/9 in weight) and 70 parts by weight of a second composite (PET/graphite powder=40/30 in weight), and then charged in the compounding equipment to form a composite of a dual-phase polymer. The composite had a heat deformation temperature (HDT) of 108.7° C. and a thermal conductivity of 1.0 W/m·K.

### Example 18

The ABS, the glass fiber, the PET, and the graphite powder were weighted according to ratios of 30 parts by weight of a first composite (ABS/glass fiber=25.5/4.5 in weight) and 70 parts by weight of a second composite (PET/graphite powder=40/30 in weight), and then charged in the compounding equipment to form a composite of a dual-phase polymer. The composite had a heat deformation temperature (HDT) of 109.6° C. and a thermal conductivity of 1.6 W/m·K.

### Example 19

The PBT, the glass fiber, the PET, and the graphite powder were weighted according to ratios of 30 parts by weight of a first composite (PBT/glass fiber=21/9 in weight) and 70 parts by weight of a second composite (PET/graphite powder=40/30 in weight), and then charged in the compounding equipment to form a composite of a dual-phase polymer. The composite had a heat deformation temperature (HDT) of 179.2° C. and a thermal conductivity of 1.9 W/m·K.

### Example 20

The PBT, the glass fiber, the PET, and the graphite powder were weighted according to ratios of 30 parts by weight of a first composite (PBT/glass fiber=25.5/4.5 in weight) and 70 parts by weight of a second composite (PET/graphite powder=40/30 in weight), and then charged in the compounding equipment to form a composite of a dual-phase polymer. The composite had a heat deformation temperature (HDT) of 164° C. and a thermal conductivity of 1.7 W/m·K.

### Example 21

The Nylon 6, the glass fiber, the PET, and the graphite powder were weighted according to ratios of 30 parts by weight of a first composite (Nylon 6/glass fiber=21/9 in weight) and 70 parts by weight of a second composite (PET/graphite powder=40/30 in weight), and then charged in the compounding equipment to form a composite of a dual-phase polymer. The composite had a heat deformation temperature (HDT) of 202.8° C. and a thermal conductivity of 1.7 W/m·K.

### Example 22

The Nylon 6, the glass fiber, the PET, and the graphite powder were weighted according to ratios of 30 parts by weight of a first composite (Nylon 6/glass fiber=25.5/4.5 in weight) and 70 parts by weight of a second composite (PET/graphite powder=40/30 in weight), and then charged in the compounding equipment to form a composite of a dual-phase polymer. The composite had a heat deformation temperature (HDT) of 200.4° C. and a thermal conductivity of 1.6 W/m·K.

### Example 23

The Nylon 66, the glass fiber, the PET, and the graphite powder were weighted according to ratios of 30 parts by weight of a first composite (Nylon 66/glass fiber=21/9 in weight) and 70 parts by weight of a second composite (PET/graphite powder=40/30 in weight), and then charged in the compounding equipment to form a composite of a dual-phase polymer. The composite had a heat deformation temperature (HDT) of 220.8° C. and a thermal conductivity of 1.8 W/m·K.

### Example 24

The Nylon 66, the glass fiber, the PET, and the graphite powder were weighted according to ratios of 30 parts by weight of a first composite (Nylon 66/glass fiber=25.5/4.5 in weight) and 70 parts by weight of a second composite (PET/graphite powder=40/30 in weight), and then charged in the compounding equipment to form a composite of a dual-phase polymer. The composite had a heat deformation temperature (HDT) of 172.7° C. and a thermal conductivity of 1.7 W/m·K.

### Example 25

The PP, the glass fiber, the PET, and the graphite powder were weighted according to ratios of 30 parts by weight of a first composite (PP/glass fiber=21/9 in weight) and 70 parts by weight of a second composite (PET/graphite powder=40/30 in weight), and then charged in the compounding equipment to form a composite of a dual-phase polymer. The composite had a heat deformation temperature (HDT) of 151.3° C. and a thermal conductivity of 1.6 W/m·K.

### Example 26

The PP, the glass fiber, the PET, and the graphite powder were weighted according to ratios of 30 parts by weight of a first composite (PP/glass fiber=25.5/4.5 in weight) and 70 parts by weight of a second composite (PET/graphite powder=40/30 in weight), and then charged in the compounding equipment to form a composite of a dual-phase polymer. The composite had a heat deformation temperature (HDT) of 136.7° C. and a thermal conductivity of 1.7 W/m·K.

The raw material ratios and properties of the products in Comparative Example 8 and Examples 17 to 26 were tabulated and are shown in Table 4.

TABLE 5

| | | | | | | | | | Thermal | |
|---|---|---|---|---|---|---|---|---|---|---|
| | | | Glass | | | | Nylon | | conductivity | |
| | PET | graphite | fiber | ABS | PBT | Nylon 6 | 66 | PP | (W/m · K) | HDT (° C.) |
| Comparative | 70 | 30 | 0 | 0 | 0 | 0 | 0 | 0 | 1.7 | 95.4 |
| Example 8 | | | | | | | | | | |
| Example 17 | 40 | 30 | 9 | 21 | 0 | 0 | 0 | 0 | 1.0 | 108.7 |
| Example 18 | 40 | 30 | 4.5 | 25.5 | 0 | 0 | 0 | 0 | 1.6 | 109.6 |
| Example 19 | 40 | 30 | 9 | 0 | 21 | 0 | 0 | 0 | 1.9 | 179.2 |
| Example 20 | 40 | 30 | 4.5 | 0 | 25.5 | 0 | 0 | 0 | 1.7 | 164 |
| Example 21 | 40 | 30 | 9 | 0 | 0 | 21 | 0 | 0 | 1.7 | 202.8 |
| Example 22 | 40 | 30 | 4.5 | 0 | 0 | 25.5 | 0 | 0 | 1.6 | 200.4 |
| Example 23 | 40 | 30 | 9 | 0 | 0 | 0 | 21 | 0 | 1.8 | 220.8 |
| Example 24 | 40 | 30 | 4.5 | 0 | 0 | 0 | 25.5 | 0 | 1.7 | 172.7 |
| Example 25 | 40 | 30 | 9 | 0 | 0 | 0 | 0 | 21 | 1.6 | 151.3 |
| Example 26 | 40 | 30 | 4.5 | 0 | 0 | 0 | 0 | 25.5 | 1.7 | 136.7 |

As shown in Examples and Comparative examples, although the composites of the dual-phase polymer and the composite of the single polymer had the same carbon material content, the composites of the dual-phase polymer had higher thermal conductivity or higher thermal resistance than that of the composite of the single polymer.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A high thermally conductive composite, comprising:
a first composite consisting of glass fiber distributed into polyphenylene sulfide, acrylonitrile-butadiene-styrene copolymer, polybutylene terephthalate, poly(ε-caprolactam), polyhexamethylene adipamide, or polypropylene; and
a second composite consisting of carbon material distributed into polyethylene terephthalate,
wherein the first composite and the second composite have a co-continuous and incompatible dual-phase manner.

2. The high thermally conductive composite as claimed in claim 1, wherein the first composite and the second composite have a weight ratio of 1:9 to 3:7.

3. The high thermally conductive composite as claimed in claim 1, wherein the glass fiber and the polyphenylene sulfide, acrylonitrile-butadiene-styrene copolymer, polybutylene terephthalate, poly(ε-caprolactam), polyhexamethylene adipamide, or polypropylene of the first composite have a weight ratio of 10:90 to 40:60.

4. The high thermally conductive composite as claimed in claim 1, wherein the polyphenylene sulfide, acrylonitrile-butadiene-styrene copolymer, polybutylene terephthalate, poly(ε-caprolactam), polyhexamethylene adipamide, or polypropylene has a melt flow index of 70 g/min to 5000 g/min.

5. The high thermally conductive composite as claimed in claim 1, wherein the polyethylene terephthalate and the carbon material of the second composite have a weight ratio of 10:90 to 70:30.

6. The high thermally conductive composite as claimed in claim 1, wherein the polyethylene terephthalate has an intrinsic viscosity of 0.4 dL/g to 2 dL/g.

7. The high thermally conductive composite as claimed in claim 1, wherein the carbon material comprises graphite, graphene, carbon fiber, carbon nanotube, or combinations thereof.

8. An illumination device, comprising:
a lamp base; and
a heat dissipation module disposed on the lamp base,
wherein the heat dissipation module is formed of the high thermally conductive composite as claimed in claim 1.
